(19) United States
(12) Patent Application Publication
(10) Pub. No.: US 2010/0237640 A1
(43) Pub. Date: Sep. 23, 2010

(54) Pet waste collection and temporary storage system

(76) Inventor: Sam Pong Chia, Pasadena, CA (US)

Correspondence Address: Dr. Sam P. Chia, 1599 San Pasqual Street, Pasadena, CA, 91106, US

(21) Appl. No.: 12/383,139

(22) Filed: Mar. 20, 2009

(51) Int. Cl. A01K 29/00; A44B 21/00

(52) U.S. Cl. 294/1.3; 24/458

(57) ABSTRACT

A pet waste collection and temporary storage system, comprising a pet waste receptacle container and a leash clip. The disposable container is ergonomically designed, has a lid for closure, and includes a detachable scooper tab. The pet owner needs only two fingers to expand the container from its flattened state. The tab is detached from the back of the container to handle animal waste and is discardable into the container after use. The container's lid may be locked into the closing position by pushing down on the lid with one finger. The container is attached to any preferred location in the pet owner's vicinity via a reusable leash clip. The attachment remains secure against ordinary motions of the pet owner or the leash, but may be disconnected by a ripping motion. The container is simple to operate, easy to manufacture, and 100% biodegradable.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to an improved method of temporarily containing and disposing animal waste.

Many cities and municipalities currently require owners of domestic animals to remove and dispose of the animals' waste in public places. Current methods of removing waste range from collecting the waste products with plastic bags or specially designed containers to ease owner's transport of their animals' waste and minimize contact with such waste.

The prior art is exemplified in the following United States patents developed in a search:

| Bergquist | D. 434,194 | Nov. 21, 2000 |
|---|---|---|
| Allan | 3,971,503 | Jul. 27, 1976 |
| Mathis | 4,205,869 | Jun. 3, 1980 |
| Ullger | 4,222,598 | Sep. 16, 1980 |
| Claras | 4,230,354 | Oct. 28, 1980 |
| Tokuzumi | 4,252,356 | Feb. 24, 1981 |
| Grahn | 4,974,893 | Dec. 4, 1990 |
| Wootten | 5,033,780 | Jul. 23, 1991 |
| Nelson | 5,186,384 | Feb. 16, 1993 |
| Ring | 5,564,762 | Oct. 15, 1996 |
| Hawk | 5,829,671 | Nov. 3, 1998 |
| Fronfrias | 6,932,399 | Aug. 23, 2005 |

Current methods of containing, transporting, and disposing animal waste have several drawbacks. First, plastic bags and apparatuses containing non-biodegradable materials may remain inert in landfills for thousands of years. With current societal trends toward recycling and minimizing waste, creating extra garbage is unacceptable to many environmentally-conscious pet owners.

Second, current methods do not provide enough of a barrier between the pet owner and the animal waste, requiring the owner to either hand-carry the waste container or secure it at some personal space close to the owner (such as pockets or backpacks), where the waste can come into close contact with other personal items. Owners may have to carry the waste container by hand for long distances if no garbage receptacle is immediately available and must deal with the unpleasantness of keeping animal waste in close proximity.

Third, current methods are limited by cost or simple physics from being airtight, crush-proof or seepage-proof. Combined with the drawbacks earlier described, current waste containers risk contaminating its surrounding environment and causing inconvenience to the owner.

Fourth, even if current methods do isolate the waste from the pet owner, no efficient or cost-effective method exists to securely attach the waste container for the duration of the walk.

### BRIEF SUMMARY OF THE INVENTION

The instant invention presents an ergonomic, sanitary, and environmentally friendly way to temporarily contain animal waste awaiting disposal.

The instant invention comprises a waste receptacle container made of 100% recyclable and biodegradable paperboard material, attached via a leash clip, which can then be secured to the animal's leash or other location convenient to the pet owner. The preferred embodiment of the waste receptacle container is made from foldable paperboard with a smooth, waxy side designed to resist short-term soiling by animal waste. The paperboard is folded and glued into a flattened container for storing or shipping. Pieces of paperboard form the container's closable lid, a loop to be attached to the clip, and a removable scooper tab.

The flattened container is ordinarily stored or shipped unexpanded and stacked. Pet owners may transport a flattened container easily inside pockets or purses or hang it on the leash clip. When the owner desires to use the container, he lifts the lid from its folded position and squeezes the container on opposite sides along fold lines, which causes the container to expand and retain a roughly trapezoidal shape. The owner can expand the container with two fingers. The owner detaches the scooper tab affixed to the back of the container by lifting and tearing the pre-cut paperboard tab.

The container is laid on the ground near the animal waste with its lid side placed closest to the ground. The owner folds the lid underneath the container and uses the scooper tab to leverage the waste into the container. The soiled scooper tab is then deposited into the container and the lid folded back over the container. A small protruding tab on the lid is inserted into a corresponding notch at the top of the container to secure the lid over the container. Securing the lid can be accomplished with one finger.

The leash clip comprises a ribbon attached to a hook clip at one end and a loop at the other end large enough for the hook clip to pass through. The owner will have already secured the leash clip to the leash or some other convenient location by tying a knot. This can be accomplished easily by wrapping the fabric ribbon around the leash and inserting the hook clip into the loop at the end of the ribbon and pulling on the clip. The action causes the ribbon to tighten around the leash. The owner then attaches the used waste container to the clip by sliding the cardboard loop over the clip. The weight of the waste container, exerted on the ribbon and plastic clip, prevents the container from sliding on the leash. The owner may adjust the tension of the knot to achieve the desired position of the leash clip.

When the owner reaches a garbage receptacle, the waste container is removed from the leash clip by a ripping motion which severs the cardboard loop. The waste container is disposed and the leash clip is retained at its current location for future use.

The present invention addresses the inadequacies of prior art in several ways. It solves the problem of having to hold or store the waste container before reaching the next garbage receptacle by hanging the waste on the leash and keeping it away from the owner. The present invention also frees the owner's hand to accomplish other tasks while walking the animal and is comparatively simple to operate, requiring only two fingers to expand and one finger to close its lid.

The present invention avoids expensive materials, complicated manufacturing, and reduces overall waste because by hanging the container at an external location selectable by the pet owner, it does not have to be made sturdy enough to survive the bottom of a backpack or leak-proof enough to avoid soiling a pocket. The use of a durable, reusable leash clip avoids the prior art's problems of having the waste container separating from the leash before a suitable garbage receptacle is found, particularly if thin or wire-like leashes are used. Another problem avoided by the present invention is container sliding when directly attached to the leash.

Furthermore, the disposable part of the present invention, which includes the whole of the waste container, is made of 100% recyclable materials and is 100% biodegradable. By providing a durable and reusable leash clip, the invention is less prone to failure than the prior art and also creates less garbage overall.

### BRIEF DESCRIPTION OF THE SEVERAL VIEWS OF THE DRAWING

FIG. 1 is a front view of the waste receptacle container in its flattened state with the closable lid facing forward.

FIG. 2 is a rear view of the container in its flattened state with the scooper tab assembly attached.

FIG. 3 is a front view of the container in its expanded state with the lid closed.

FIG. 4 is a rear view of the container in its expanded state with the scooper tab attached.

FIG. 5 is a side view of the container in its expanded state with the lid closed.

FIG. 6 is a perspective view of the container in its expanded state with the lid closed.

FIG. 7 illustrates the flat blank from which the container is formed along with the scooper tab assembly.

FIGS. 8 and 9 are front and side views of the leash clip.

FIG. 10 illustrates the proper threading of the leash clip onto a pet leash.

FIG. 11 illustrates one possible location of the leash clip in a tightened configuration.

FIG. 12 illustrates a container in its flattened state attached to the leash clip, which is attached to a pet leash.

### DETAILED DESCRIPTION OF THE INVENTION

The preferred embodiment of the present invention is represented by a waste receptacle container 10 and a leash clip 30.

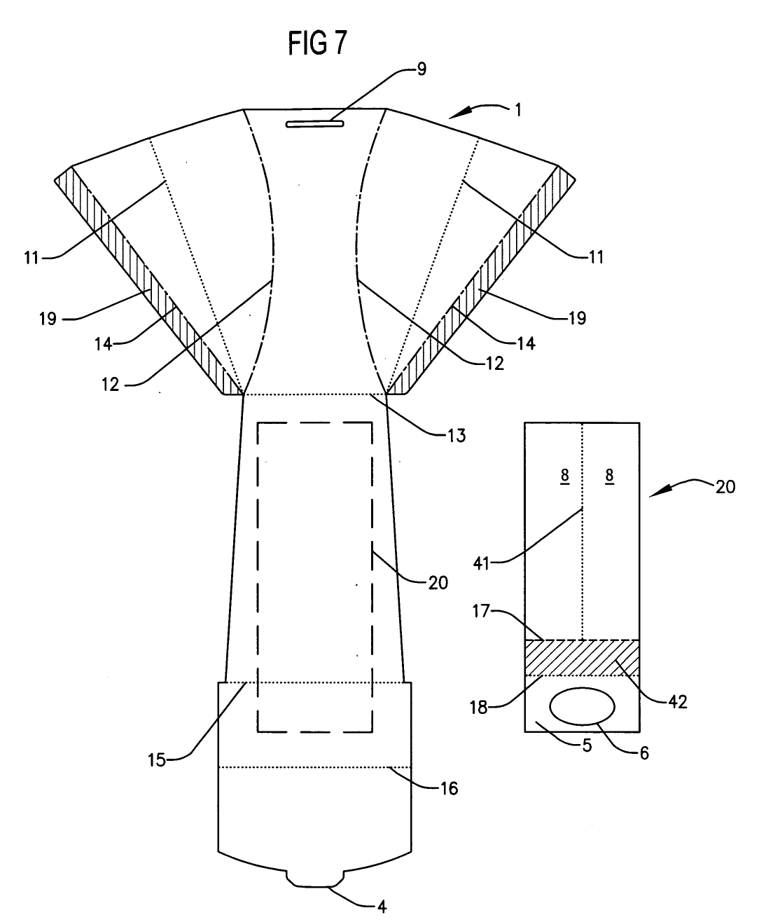

The waste receptacle container 10 is formed from a unitary blank paperboard 1 represented in FIG. 7 with a smooth waxy side facing up in the illustration and a rough side facing down. The smooth waxy side, which forms the inner surface of container 10, retards soiling by pet waste. The unitary blank paperboard 1 is folded inwards along fold lines 11 and 13, and score lines 12 and 14. Lines 11 and 13 are formed by folding the paperboard. Lines 12 and 14 are scored by breaking the outside rough surface of the paperboard to facilitate formation of the expanded shape of container 10. Glue is applied on the waxy side of surface 19 and attached to the outer edges of surface 7 so that the material may be attached to itself to form container 10.

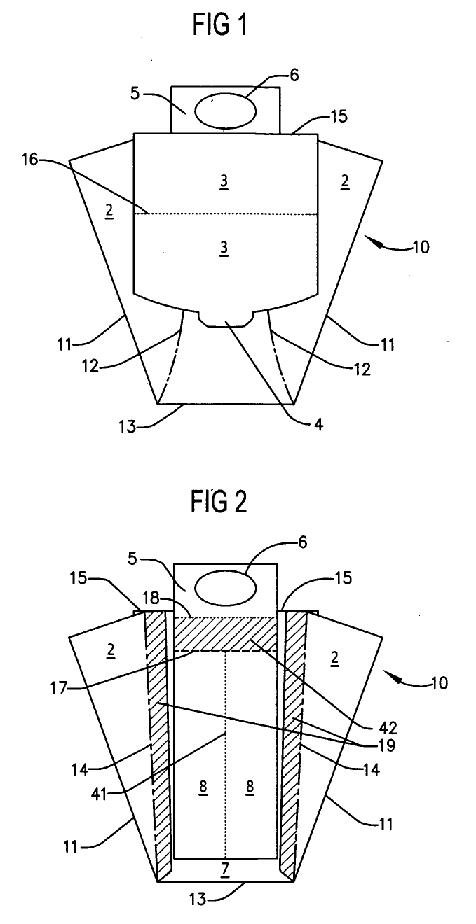

Tab 20 comprises a rectangular unitary blank paperboard, with perforation 17 and fold line 18 as illustrated in FIG. 7. An oval hole 6 is cut in tab 20, forming a paperboard loop 5 with an intentionally thin strip of material near the edge of tab 20. As shown in FIG. 2, Tab 20 is then attached to surface 7 via glue surface 42, where fold line 18 on tab 20 is aligned with fold line 15. The non-glued portions of tab 20 hangs freely from surface 7. FIG. 7 illustrates the location of tab 20 as attached on the rear side of paperboard 1. Lid 3 is folded downwards toward container 10's opening via fold line 15, as illustrated in FIG. 1. Lid 3 partially covers surfaces 2 and form container 10's flattened state.

To form container 10's expanded state, the pet owner lifts lid 3 upwards from the flattened container 10 and squeezes the container inward along fold lines 11, causing container 10 to acquire a third dimension. The owner applies enough pressure to cause lines 11 to completely flatten out and locks container 10 in its expanded state. This action requires only the thumb and another finger of one hand, and no additional pressure or maneuvering is required to keep container 10 in its expanded shape. The curve of lines 12 creates tension in the container as the owner applies pressure along lines 11 and prevents the container from self-collapsing when pressure is released. Furthermore, the curve of lines 12 gives surfaces 2 a slight curve and facilitates owner's grip on container 10.

When needed, the pet owner acquires waste by detaching scooper tab 8 from tab 20 along perforation 17. Lid 3 is folded backwards via fold line 15 toward the outside of container 10 to expose the interior of container 10 toward the ground with fold line 15 nearest the ground. Pet waste is then leveraged into container 10 with scooper tab 8. The owner may elect to fold scooper tab 8 using fold line 41 to give scooper tab 8 extra rigidity. The soiled scooper tab 8 is inserted into container 10. The owner then folds lid 3 back toward container 10 and applies pressure on fold line 16 so that lid tab 4 inserts into notch 9. This action, which is a one-finger operation, immobilizes lid 3, effectively closing container 10. The owner then attaches container 10 to leash clip 30.

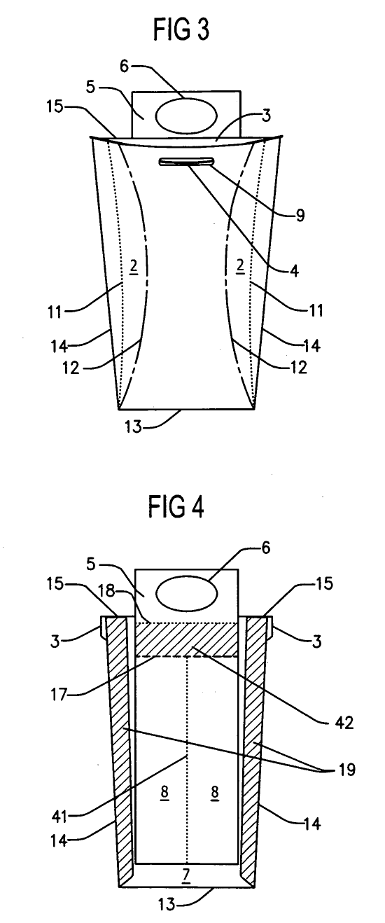

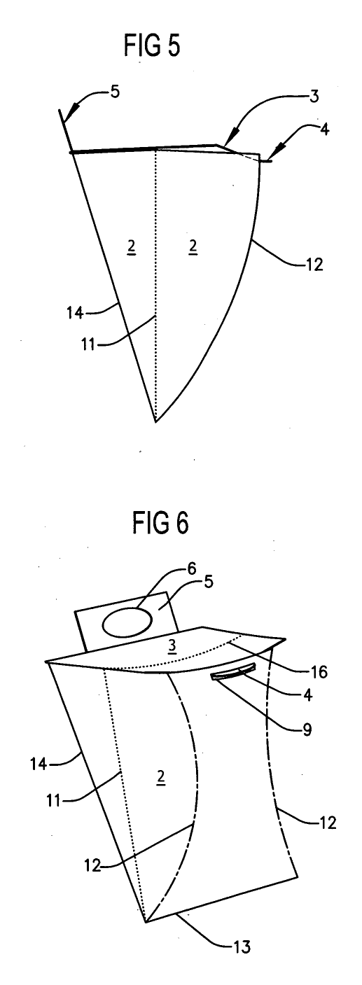

FIGS. 3-6 show the expanded and closed container 10. FIG. 6 in particular shows lid 3 in a concave upward shape. FIG. 5 illustrates the minor overhang formed from a slightly bent lid 3. Such a bent shape allows lid 3 to achieve a tighter fit with the opening of container 10 by exerting some downward pressure within the container. Lid 3's shape also facilitates an ergonomic closure by minimizing the effort on the pet owner's part. Lid tab 4 is visible in FIGS. 3, 5, and 6 as fitting within notch 9.

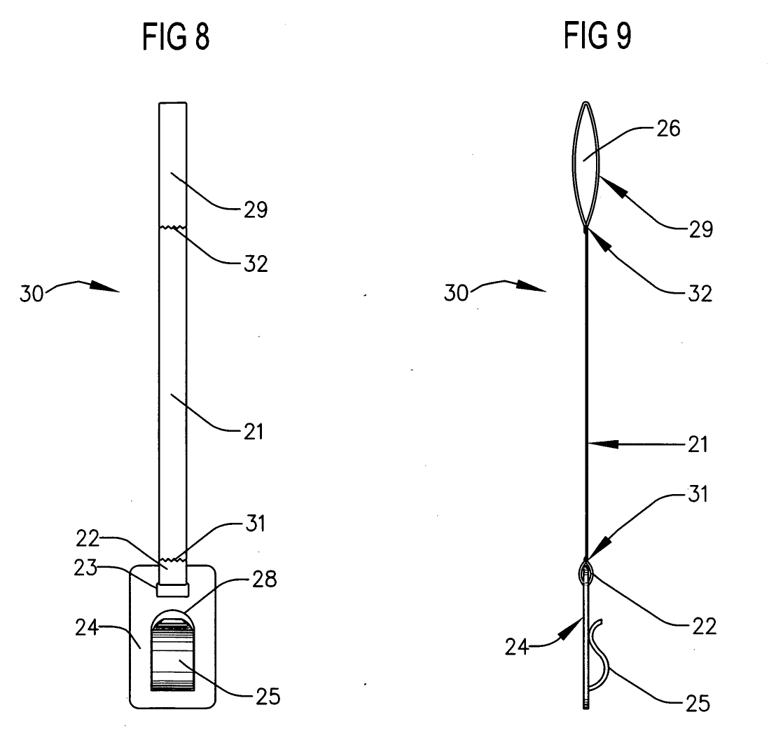

FIGS. 8 and 9 illustrate leash clip 30. Leash clip 30 comprises hook clip 24, made of durable, rigid material, and ribbon 21, made of durable, woven material. Hook clip 24 may be made of materials such as metal or plastic. Within hook clip 24, hole 28 is formed from molding tab 25 into an S-shape as shown in FIG. 9. Rectangular hole 23 is cut within hook clip 24 to allow ribbon 21 to connect to hook clip 24.

Ribbon 21 may be made of flat, woven material such as fabric, synthetic fibers, or thick paper. Ribbon 21 comprises of two loops, 22 and 29, formed by folding the material back upon itself and uniting the material with stitches or adhesive 31 and 32. Loop 22 forms a durable connection between ribbon 21 and clip 24. Loop 29 is slightly larger than the width of hook clip 24 to allow hook clip 24 to pass in its entirety through loop 29.

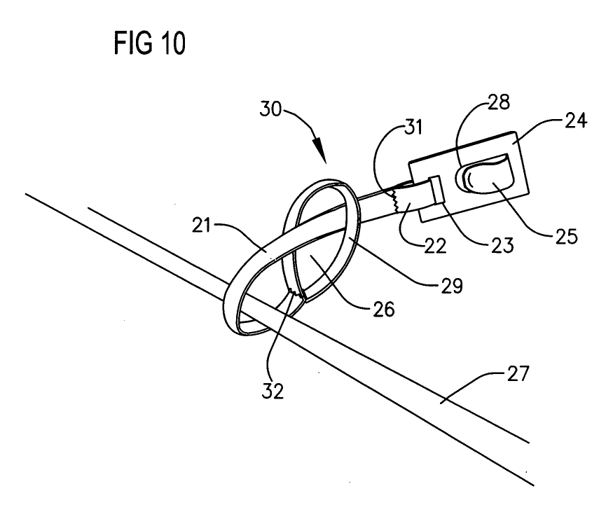

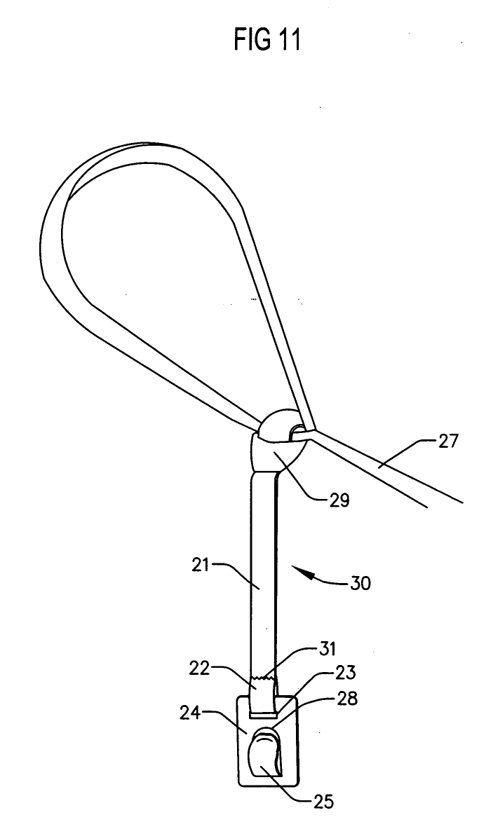

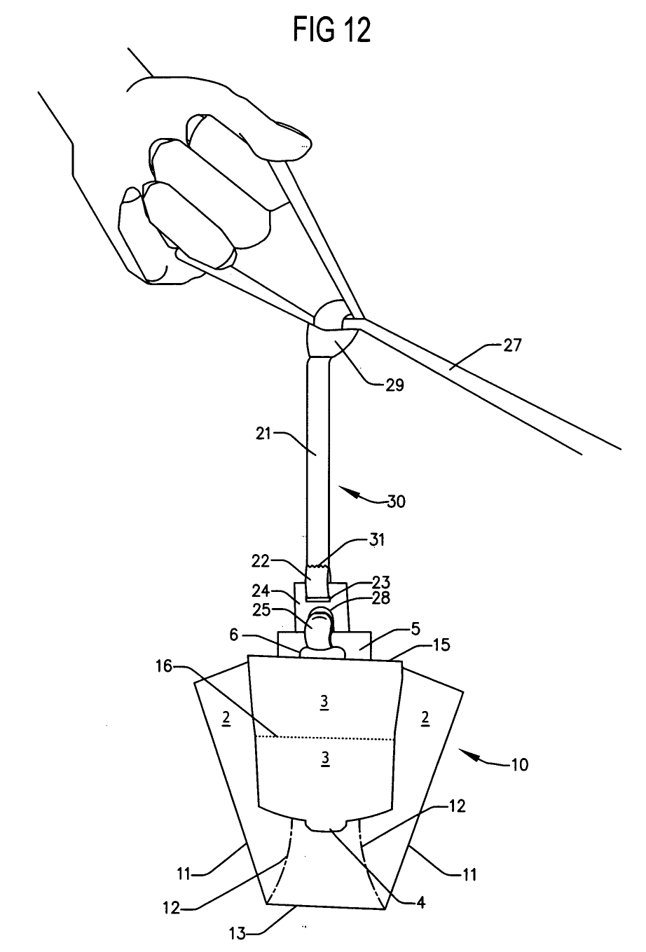

To attach leash clip 30 to a pet leash 27, the owner wraps ribbon 21 around pet leash 27 and inserts hook clip 24 into loop 29, as shown in FIG. 10. The resulting knot may be tightened by pulling on hook clip 24. The inherent friction of ribbon 21's material prevent leash clip 30 from sliding around easily. The pet owner may adjust the tension depending on where leash clip 30 is attached. Leash clip 30 may be attached to any convenient part of pet leash 27 or any other part of owner's immediate vicinity (such as the outside of a backpack, a belt, or any downwind location). FIGS. 11 and 12 illustrate a convenient location on pet leash 27 where it is easily accessible by pet owner.

Container 10 may be attached to leash 30 by passing paperboard loop 5 between the protruding lip of tab 25 and hook clip 24 so loop 5 comes to rest at the bottom of hole 28. Because of tab 25's S-shape, loop 5 is unlikely to separate from hook clip 24 under the ordinary motions experienced while walking a pet. Such motions transferred by pet leash 27 will only cause loop 5 to flex.

When a suitable garbage receptacle is found, the owner detaches container 10 from leash clip 30 by a sudden ripping motion. This causes the thin paperboard of loop 5 to detach cleanly from clip 24. Container 10 is deposited into the garbage receptacle. Leash clip 30 is retained in its location for reuse. Since container 10 is only intended for one-time use, it can be made more economically with less material and reduces the overall garbage generated.

Although the preferred embodiment has been described above by way of example only, it will be understood by those skilled in the art that modifications may be made to the disclosed embodiment without departing from the scope of the invention, defined by the subsequent appended claims.

What is claimed is:

1. A pet waste receptacle apparatus, comprising:
a fully collapsible container with a back wall, a front wall, two side walls responsive to pressure that expands the container, and a closable lid with a tab to be inserted into a notch in the front wall;
a scooper tab and loop assembly with a detachable scooper tab and a loop, attached to the container.

2. The apparatus of claim 1, further comprising paperboard material with one waxy side facing the inside of the collapsible container and one rough side facing the outside of the collapsible container.

3. The apparatus of claim 1 wherein the loop is attachable to a hook-like device and comprises materials subject to destruction by a ripping motion.

4. The apparatus of claim 1 wherein the boundaries between the front wall and the two side walls are scored and the side walls are longitudinally traversed by two fold lines.

5. The apparatus of claim 1 wherein the scooper tab can be folded to increase the rigidity of the scooper tab and fits in the container in its entirety.

6. The apparatus of claim 1 wherein the container can be expanded with a minimum of two human fingers and the closable lid can be closed with a minimum of one human finger.

7. The apparatus of claim 1 wherein the container further comprises two score lines of a curved nature that causes the container to expand and retain its shape upon application of pressure.

8. The apparatus of claim 1 wherein the apparatus is made from recyclable and biodegradable materials.

9. A leash clip, comprising:
a hook clip attachable to an external apparatus;
a ribbon attached at the first end to the hook clip;
the same ribbon wherein the second end forms a loop of sufficient size to pass the entirety of the hook clip through the loop.

10. The leash clip of claim 8 wherein the leash clip is made of durable materials and is used for multiple incidences of waste collection.

11. The leash clip of claim 8 wherein the hook clip is attachable to a pet leash or other location within a pet owner's immediate vicinity.

12. The leash clip of claim 8 wherein the tension of the leash clip as attached to an external object is adjustable.

13. A pet waste collection and temporary storage system, comprising:
a fully collapsible disposable container with curved interior and exterior surfaces and a closable lid;
a scooper tab and loop assembly, attached to one surface of the container;
a reusable leash clip attachable to the collapsible container at one end and to an external object at the other end.

14. The system of claim 12 wherein the container is formed with a smooth interior paperboard surface and a rough exterior paperboard surface.

15. The system of claim 12 wherein the container is separable from the leash clip by destroying the loop of the scooper tab and loop assembly with an application of a sudden force on the container.

16. The system of claim 12, further comprising a removable scooper tab that fits in the container after use.

17. The system of claim 12 wherein the container can be fully expanded by applying pressure with a minimum of two human fingers and the lid can be fully closed by applying pressure with a minimum of one human finger.

18. The system of claim 12 wherein the leash clip at the first end comprises a hook clip, attachable to the loop of the scooper tab and loop assembly.

19. The system of claim 12 wherein the leash clip at the second end forms a loop, wherein a knot may be formed with an external object by wrapping the leash clip around the object, passing the first end through the loop, and pulling the knot tight.

20. The system of claim 12 further comprising a container and assembly made from biodegradable and recycled materials.
